(19) United States
(12) Patent Application Publication
(10) Pub. No.: US 2005/0108704 A1
(43) Pub. Date: May 19, 2005

(54) Software distribution application supporting verification of external installation programs

(75) Inventors: Claudio Marinelli, Latina (IT); Luigi Pichetti, Rome (IT); Marco Secchi, Rome (IT)

Correspondence Address: Jeffrey S. LaBaw;International Business Machines, Intellectual Property Law, 11400 Burnet Road, Austin, TX, 78758, US

(73) Assignee: INTERNATIONAL BUSINESS MACHINES CORPORATION, ARMONK, NY (US)

(21) Appl. No.: 10/845,545

(22) Filed: May 13, 2004

(30) Foreign Application Priority Data
Nov. 14, 2003 (FR) 03368099.2

(51) Int. Cl. G06F 9/445; G06F 9/44

(52) U.S. Cl. 717/174

(57) ABSTRACT

The present invention relates to a software distribution application, which is used to deploy software products to multiple endpoints. The software distribution application supports either bundled packages (detailing all the operations to be executed on the endpoints) or native packages (including a simple command for launching an external installation program); an introspection attribute is added to discriminate the two types of packages. Whenever an endpoint receives (314) a native package, a snapshot of the endpoint is taken (332) using a reverse engineering tool (such as AutoPack). The desired software product is then installed launching (334) the corresponding external installation program. As soon as the installation has been completed, a further snapshot of the endpoint is taken (336). A reversed package is built (338-339) according to a comparison between the two snapshots. The reversed package is then used to verify whether the actions executed on the endpoint at the installation time are still in place. In this way, it is possible to repair any inconsistency in the software configuration of the endpoint automatically.

### TECHNICAL FIELD

The present invention relates to the data processing field, and more specifically to a software distribution method and a corresponding system.

### BACKGROUND ART

Managing configuration changes in a data processing system is a time consuming activity, particularly when the system includes a great number of target computers to which new software products must be distributed. A typical example is that of a large network with hundreds of workstations where software products are periodically upgraded in order to be abreast of the information technology development.

Software distribution applications have been proposed in the last years to assist an administrator in efficiently managing deployment of software products from a central site of the system. An example of software distribution application is the “Tivoli Configuration Manager” by IBM Corporation.

A software distribution application controls building of packages including a specification of actions to be executed for reaching a target state of selected resources; each package further embeds an image of entities to be installed on the target computers. The package is transmitted to each target computer, and the corresponding actions are interpreted so as to enforce the desired software configuration.

Some software distribution applications also provide the possibility of verifying whether the resources of the computer are still in the target state, which has been enforced by the actions executed at the distribution time. This feature allows detecting any inconsistencies in the configuration of the target computer (for example, caused by the corruption or the deletion of some files). In this way, it is also possible to restore the desired configuration of the target computer automatically.

A problem is encountered whenever the software distribution application must handle the deployment of software products, which are provided by third parties with corresponding (native) external installation programs.

A solution known in the art is that of embedding each external installation program into a package. The package then includes a simple command for launching the execution of the external installation program. However, in this case no detailed information about the content of the external installation program is available. Therefore, the software distribution application is unable to monitor the compliance of the target computer to the desired configuration enforced by the external installation program.

A different technique is based on the generation of a new package corresponding to the external installation program. For this purpose, the external installation program is applied on a preparation machine (preferably, with no other products installed). The software distribution application then leverages a tool (such as the AutoPack), which automatically detects any change occurred on the preparation machine during the installation. In detail, the tool takes a snapshot of the preparation machine before the installation and a further snapshot after the installation; the tool generates the package according to the differences between the two snapshots. The package is then distributed to the target computers for its application (instead of the external installation program).

A drawback of the solution described above is that the package so obtained strongly depends on the structure of the preparation machine. Therefore, any difference of the target computer (wherein the package will be applied) with respect to the preparation machine can cause inconsistencies in the enforced configuration. This problem is particular acute when the external installation program is hardware dependent (for example, a program for installing a graphic product that is configured according to the type of monitor). Indeed, during the installation on the preparation machine several hardware settings are saved (based on the characteristics of the preparation machine); these hardware settings will be included in the resulting package. Therefore, if the target computer includes incompatible devices the hardware settings forced by the package can deteriorate (or even impair) operation of the target computer.

Moreover, the above-described process generally results in the loss of the warranty offered by a vendor of the external installation program. Therefore, if any problem is experienced on the target computer no assistance is provided by the vendor (since the product has not been installed using the original program).

### SUMMARY OF THE INVENTION

It is an object of the present invention to support verification of the compliance of the target computers to the software configurations enforced by external installation programs.

It is another object of the present invention to detect any inconsistencies in the software configurations of the target computers.

It is yet another object of the present invention to prevent the enforcement of incorrect software configurations.

Moreover, it is an object of the present invention to allow monitoring the integrity of any kind of products.

Particularly, it is an object of the present invention to avoid forcing incompatible hardware settings.

It is another object of the present invention to maintain any warranty provided for the external installation programs.

The accomplishment of these and other related objects is achieved by a software distribution method including the steps of: providing a package for enforcing desired software features to a target computer, detecting a starting configuration of the target computer, applying the package on the target computer, detecting an ending configuration of the target computer resulting from the application of the package, determining at least one action executed on the target computer for reaching the ending configuration from the starting configuration according to a comparison between the starting configuration and the ending configuration, and verifying the compliance of the target computer to the at least one action.

The present invention also provides a computer program for performing the method and a corresponding program product. A software distribution system and a data processing system implementing the method are also encompassed.

The novel features believed to be characteristic of this invention are set forth in the appended claims. The invention itself, however, as well as these and other related objects and advantages thereof, will be best understood by reference to the following detailed description to be read in conjunction with the accompanying drawings.

### BRIEF DESCRIPTION OF THE DRAWINGS

FIG. 1a is a schematic block diagram of a data processing system in which the method of the invention is applicable;

FIG. 1b shows the functional blocks of a generic computer of the system;

FIGS. 2a-2c depict the main software components used for implementing the method;

FIGS. 3a-3b show a diagram describing the flow of activities relating to a software distribution process;

FIGS. 4a-4b show a diagram describing the flow of activities relating to a repair process.

### DETAILED DESCRIPTION OF THE PREFERRED EMBODIMENT

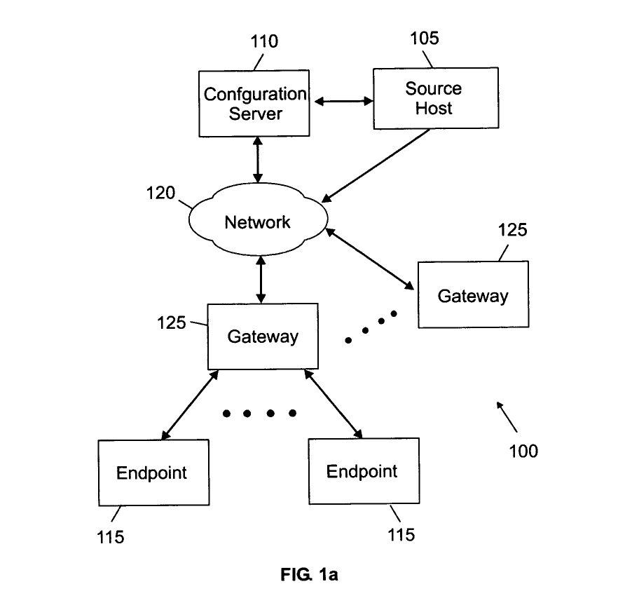

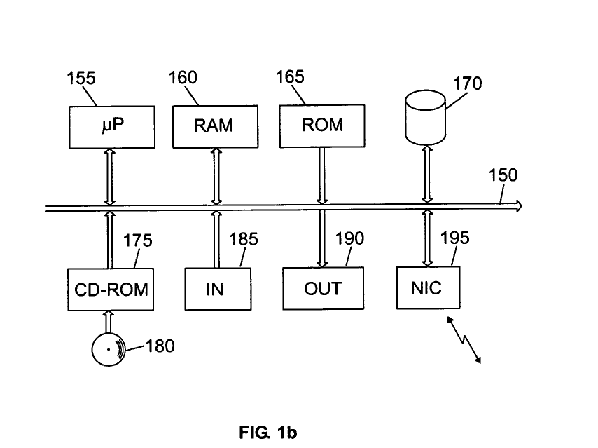

With reference in particular to FIG. 1a, a data processing system 100 with a distributed architecture is illustrated. A source host 105 operates as a preparation and testing central site for software products to be distributed throughout the system 100. The source host 105 is connected to a configuration server 110, which controls the distribution of the software products to target computers (or endpoints) 115. For this purpose, the source host 105, the configuration server 110 and the endpoints 115 are coupled through a network infrastructure 120, typically INTERNET-based. The source host 105 and the configuration server 110 access the network 120 directly; conversely, the endpoints 115 are clustered around one or more gateways 125.

As shown in FIG. 1b, a generic computer of the system (source host, configuration server, endpoint or gateway) is formed by several units that are connected in parallel to a communication bus 150. In detail, one or more microprocessors (μP) 155 control operation of the computer, a RAM 160 is directly used as a working memory by the microprocessors 155, and a ROM 165 stores basic code for a bootstrap of the computer. Several peripheral units are further connected to the bus 150 (by means of respective interfaces). Particularly, a mass memory consists of a magnetic hard-disk 170 and a driver 175 for reading CD-ROMs 180. Moreover, the computer includes input devices 185 (for example, a keyboard and a mouse), and output devices 190 (for example, a monitor and a printer). A Network Interface Card (NIC) 195 is used to plug the computer into the system.

Similar considerations apply if the computers have another structure and include equivalent units, or if the endpoints consist of different entities (such as pervasive devices, mobile phones, users logged on the computers, and the like). Moreover, the concepts of the present invention are also applicable when the system has another topology; alternatively, two or more source hosts and/or configuration servers are provided, the source host and the configuration server are combined into a single computer, or the endpoints are coupled with the source host and the configuration server in a different way.

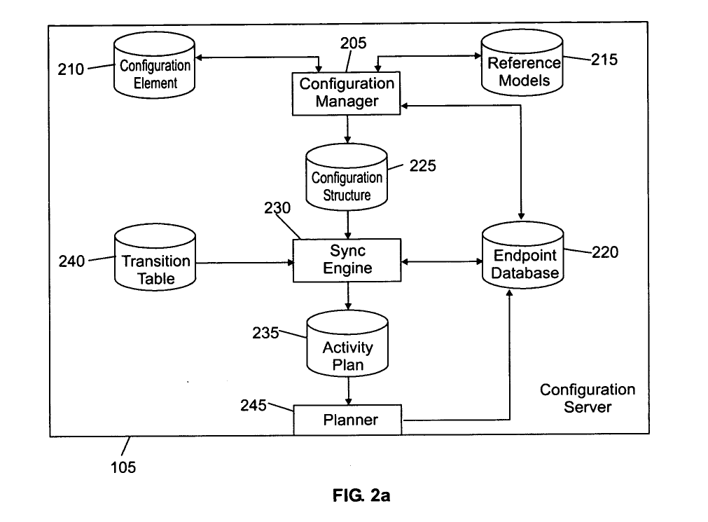

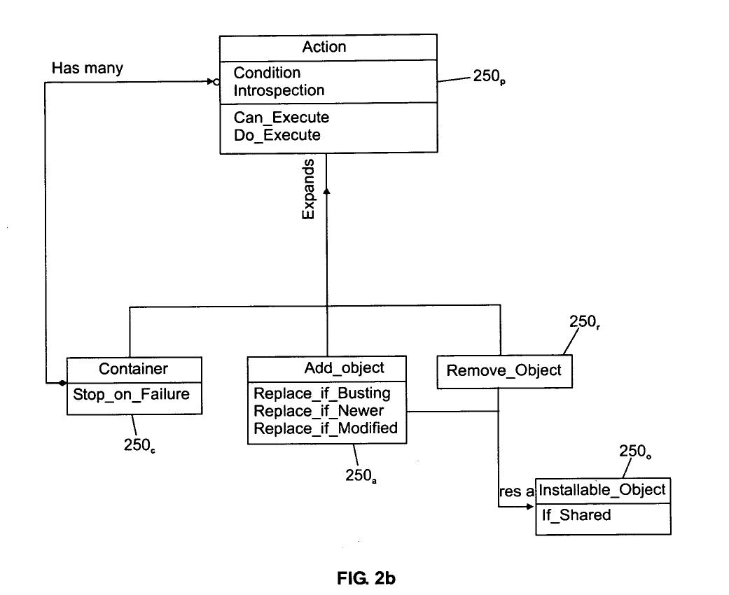

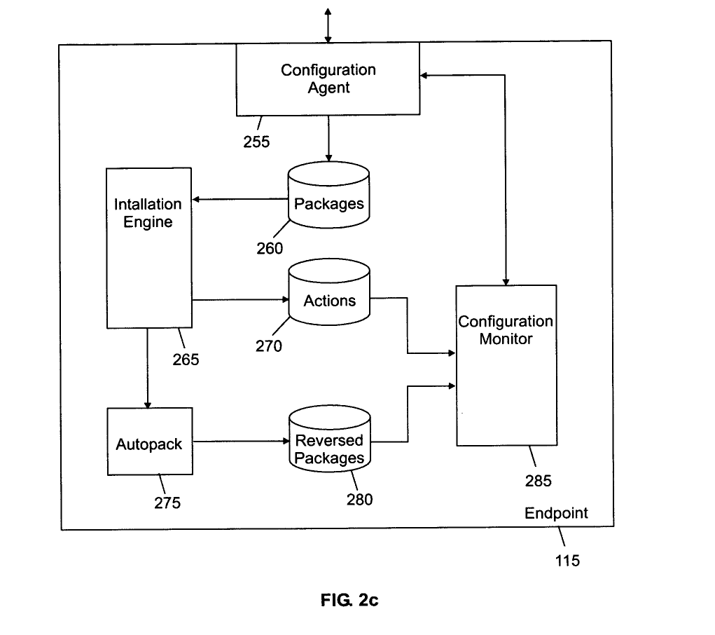

The main software components used for implementing a software distribution process in the above-described system are illustrated in FIGS. 2a-2c. The information (programs and data) is typically stored on the hard-disks of the different computers and loaded (at least partially) into the respective working memories when the programs are running. The programs are initially installed onto the hard disks from CD-ROMs.

With reference in particular to FIG. 2a, the server 105 is provided with a configuration manager 205. The configuration manager 205 controls a repository 210 of configuration elements. Each configuration element defines an entity to be used during the distribution process. Typically, the configuration element provides a reference to a package that is available on the source host; the package is used for enforcing desired software features on the endpoints (such as installing or removing a software product).

The configuration manager 205 further controls a repository 215 of reference models. Each reference model specifies a desired configuration of the endpoints subscribing to the reference model. For this purpose, the reference model indicates a target state (such as installed, committed or removed) for one or more configuration elements. The subscribers are identified by a role, which specifies a functional group of endpoints; for example, the role is defined by the computers assigned to a category of users (such as developers, secretaries, managers), belonging to a selected department, or having specific features. The endpoints of a generic role can be characterized either statically (for example, by means of a list) or dynamically (for example, by means of a query).

A database 220 stores information about all the endpoints of the system; particularly, the endpoint database 220 specifies the current (hardware and software) configuration of the endpoints, the operations carried out on the endpoints during the software distribution process, a result of each operation, and so on.

The configuration manager 205 dynamically generates a structure 225 detailing the desired configuration of the endpoints subscribing to a selected reference model; more specifically, for each endpoint belonging to the role indicated in the reference model the configuration structure 225 specifies the target state of the configuration elements defined in the reference model.

The configuration structure 225 is supplied to a synchronization engine 230, which also accesses the endpoint database 220. The synchronization engine 230 generates a plan 235, which specifies the activities to be performed on each endpoint (associated with the selected reference model) for reaching the desired configuration. For this purpose, the synchronization engine 230 exploits a transition table 240; for each configuration element and for each pair current state/target state, the transition table 240 indicates the activities required to reach the target state from the current state.

The activity plan 235 is submitted to a planner 245, which controls execution of the activities on the endpoints. Particularly, the planner instructs the source host to distribute the required packages to the desired endpoints for enforcing their application. Moreover, the planner 245 updates the information relating to each involved endpoint in the database 220, according to the result of the operations carried out on the endpoint.

As shown in FIG. 2b, a generic package is logically organized into a hierarchical structure starting from a root node. Each leaf node of the hierarchical structure corresponds to an action. Some actions are self-contained, whereas other actions take a subject referred to as an installable object; installable objects are entities to be either added to or removed from each endpoint. For example, self-contained actions trigger a restarting of the endpoint or the execution of a program, whereas actions with installable objects specify the copy, the modification or the deletion of files, registry keys, desktop images, and the like. Branch nodes of the hierarchical structure consist of containers that comprise collections of child actions sharing the default of the container.

Typically, a package (hereinafter referred to as bundled package) details all the operations to be executed during the software distribution process, in order to reach a desired state of corresponding resources of the endpoint. However, a package (hereinafter referred to as native package) can also include a simple command for launching an external installation program provided by third parties (for example, consisting of a setup package built using InstallShield or Microsoft Setup).

Each node of the hierarchical structure causes a class to be instantiated. Actions without any installable object correspond to classes that extend a generic class ACTION 250p. The class ACTION 250p exposes a series of attributes (denoted as a whole with CONDITIONS), which enable the execution of the action when evaluated to true. For example, the action is conditioned to different hardware parameters of the endpoint (such as the CPU model or the RAM size), to the operating system installed thereon, and the like. An attribute INTROSPECTION is added to implement the proposed solution. The attribute INTROSPECTION is set at the root of the hierarchical structure to indicate whether a reverse engineering process must be carried out on the endpoint when the package is applied (as described in detail in the following). The attribute INTROSPECTION is deasserted for the bundled packages and is asserted for the native packages.

The class ACTION 250p further exposes a method CAN_EXECUTE, which makes it possible to verify whether the action can be performed on the endpoint; a method DO_EXECUTE is used to actually perform the action. Both the methods CAN_EXECUTE and DO_EXECUTE are called specifying a parameter taking a value EXECUTE (for carrying out the action) or a value REVERSE (for undoing the action).

Actions with an installable object specifying an entity to be removed from the endpoint instantiate a class REMOVE_OBJECT 250r; the class REMOVE_OBJECT 205r extends the class ACTION 250p and then inherits all its characteristics. On the other hand, actions specifying an entity to be added to the endpoint instantiate a class ADD_OBJECT 250a, which extends the class ACTION 250p as well. The class ADD_OBJECT 250a exposes a series of attributes for the purpose of entity version control (whose values are set during creation of the package). For example, an attribute REPLACE_IF_EXISTING specifies that a pre-existing entity may be replaced, an attribute REPLACE_IF_NEWER specifies that only an old version of the entity may be replaced, and an attribute REMOVE_IF_MODIFIED specifies that a pre-existing entity must be removed when modified.

The classes ADD_OBJECT 250a and REMOVE_OBJECT 250r have an associated class INSTALLABLE_OBJECT 250o corresponding to the respective entity (to be added or to be removed). The class INSTALLABLE_OBJECT 250o exposes an attribute IS_SHARED, which is asserted when the entity can be shared among multiple packages.

Containers instantiate a class CONTAINER 250c, which extends the class ACTION 250p. The class CONTAINER 250c exposes a further attribute STOP_ON_FAILURE (whose value is set during the creation of the package); this attribute enables the result of an action to condition the execution of its child actions.

Once the hierarchical structure of the package has been defined, a software package file that serializes the hierarchical structure into a binary representation is generated. For this purpose, the hierarchical structure is traversed top-down and a method ENCODE is called on each class. The called methods generate a series of records, each one given a unique name identifying the corresponding class; the record contains the values set for the attributes of the class, the definition of the respective conditions, and the list of children depending thereon (if any).

Alternatively, the package is described with a plain text file. The syntax of the text file is based on a sequence of stanzas, starting from a top-level stanza corresponding to the package. Each stanza represents an action; stanzas can be nested, with stanzas that contain other stanzas representing a container. In this case, the software package file is generated interpreting this text file with conventional parsing techniques.

The package (also referred to as software package block) is built from the software package file. For this purpose, the software package file is read, and the name assigned to each record is used to access a lookup table specifying the corresponding class; once the class has been instantiated, a method DECODE is called on the class. The called methods generate the corresponding hierarchical structure of the package. The hierarchical structure is then traversed, and a method BUILD is called on each class. These methods retrieve and add an image of the required installable objects to the package.

The package may be prepared in two different formats. In a format BUILT, the images of the installable objects are imported into the package at the preparation time; in this way, the entities to be installed are frozen, so that all the endpoints receive the same copy of the package at any time. Conversely, in a format NON_BUILT, the images of the installable objects are imported only when the package must be distributed (so that different endpoints always receive the last version of each entity).

Moving now to FIG. 2c, a generic endpoint 115 is provided with a configuration agent 255, which runs in the background for controlling communication with the configuration server and the source host (through the associated gateway). The configuration agent 255 downloads the required packages 260. The configuration agent 255 interfaces with an installation engine 265, which enforces the application of the packages 260 on the endpoint 115.

For each bundled package, the installation engine logs the corresponding actions into a repository 270; moreover, the action repository 270 includes a back-up copy of any entities updated or removed as a result of the execution of the actions on the endpoint. The installation engine 265 also leverages a reverse engineering tool 275 (for example, based on the AutoPack technology). The AutoPack tool 275 automatically builds reversed packages according to a comparison between two different snapshots of the endpoint 115 (taken before and after applying native packages); the reversed packages are stored into a further repository 280.

A configuration monitor 285 accesses the repositories 270 and 280. The configuration monitor 285 verifies whether the resources, specified in the actions stored in the repositories 270 and 280, are still in the desired target state. As described in detail in the following, the configuration monitor 285 interfaces with the configuration agent 255 (and then with the installation engine 265 as well) for restoring the target state of the resources that are not complaint with the corresponding actions any longer.

Similar considerations apply if the programs and the corresponding data are structured in another way, or if the programs are provided on equivalent computer readable media (such as a DVD). Moreover, the concepts of the present invention are also applicable when a different software distribution application is used (for example, with the activities to be submitted that are defined directly without any reference model), or when the packages have another structure. Alternatively, different software features are distributed (such as multimedia works), the introspection attribute is asserted only for some selected native packages, or the reverse engineering tool is based on an equivalent technology.

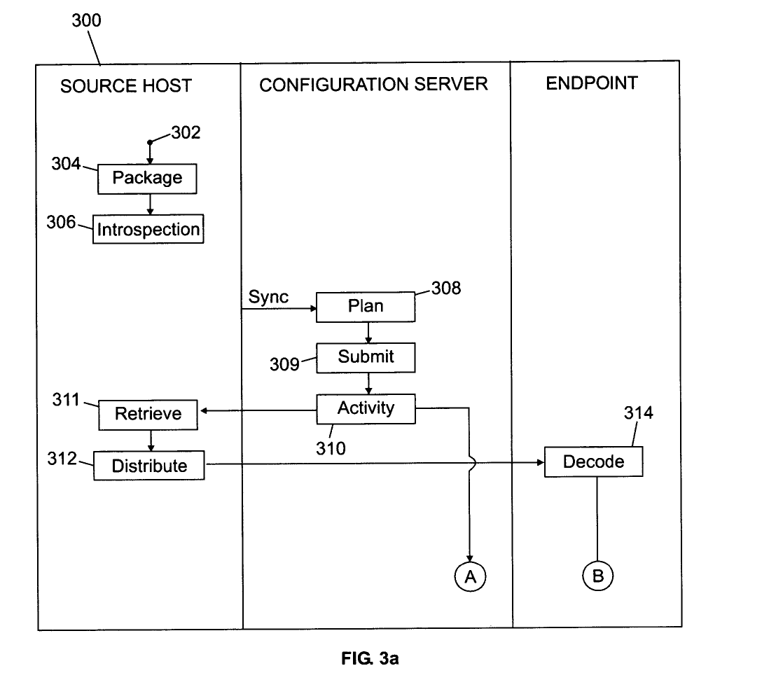

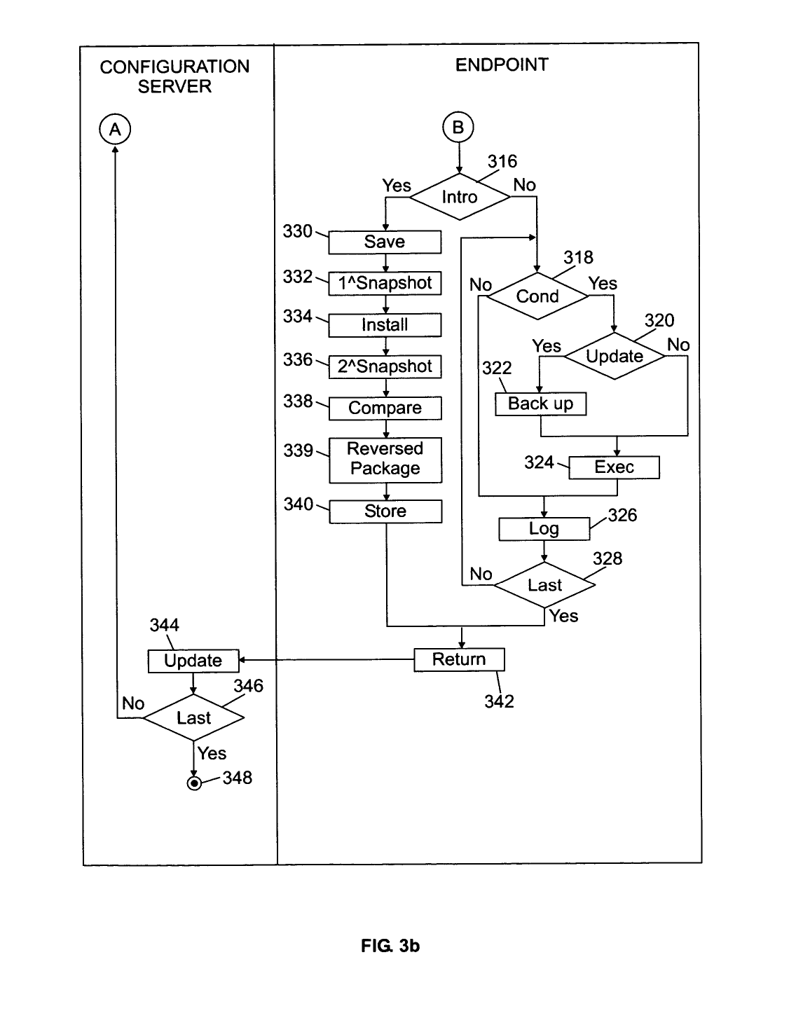

As shown in FIGS. 3a-3b, the software distribution process implements a method 300. The method begins at the black start circle 302 in the swim-lane of the source host, and then passes to block 304 wherein a new package is defined. The attribute INTROSPECTION is set at block 306 according to the type of package (bundled or native). Moving now to block 308 in the swim-lane of the configuration server, whenever an operator submits a software distribution request the synchronization engine is activated so as to generate a new plan. The plan is then submitted for execution at block 309. Each activity of the plan (starting from the first one) is actually executed at block 310; assuming that the activity consists of the application of a package on a selected endpoint, a corresponding request is transmitted to the source host. In response thereto, the source host at block 311 retrieves or builds the requested package. Continuing to block 312, the package is then transmitted to the endpoint. In detail, the endpoint is provided with a label of the package; the endpoint then opens a communication channel to the associated gateway and downloads the package using a synchronous multiplexing technique. The distribution process takes place across a hierarchy of gateways, which operate as repeaters (or depots).

Passing to block 314, the installation engine simultaneously reads and decodes the software package file, in order to create the hierarchical structure of the package in the working memory of the endpoint; in this phase, the attribute INTROSPECTION of the package is detected. The process then branches at block 316 according to the value of the attribute INTROSPECTION. If the attribute INTROSPECTION is deasserted the blocks 318-328 are executed, whereas if the attribute INTROSPECTION is asserted the blocks 330-340 are executed; in both cases, the flow of activity merges again at block 342.

Considering now blocks 318-328 (attribute INTROSPECTION deasserted), the installation engine reads and traverses the hierarchical structure of the package top-down (by calling a desired method on the root of the hierarchy, which method in turn calls the same method on its children). Particularly, for each action (starting from the first one) the installation engine checks at block 318 whether the current configuration of the endpoint meets any associated condition. If so, the method passes to decision block 320. When the action involves the update of a pre-existing entity on the endpoint (for example, the erasing or the replacing of a file), a back-up copy of the entity is performed at block 322; the method then continues to block 324. Conversely (for example, when the action involves the adding of a new file), the method descends into block 324 directly.

The action is actually executed at block 324; if the action specifies an installable object, the entity is added to or is removed from the endpoint. If the entity is shared among multiple packages, the installation engine associates a counter with the entity to indicate how many products are using the entity. The addition of a shared entity increases the counter, whereas its removal decreases the counter; the entity is physically removed from the endpoint only when the counter becomes zero (that is, no more products are using the entity). The method then passes to block 326; the same block is also reached from decision block 318 directly when the action cannot be performed on the endpoint.

Referring now to block 326, the action and the result of its evaluation are logged into the corresponding repository. A test is made at block 328 to determine whether the last action of the package has been processed. If not, the method returns to block 318 for verifying and executing (if possible) a next action. Conversely, when the last action of the package has been processed the flow of activity descends into block 342.

On the other hand, when the attribute INTROSPECTION is deasserted (decision block 316) the installation engine saves the package at block 330 for subsequent use. Proceeding to block 332, a snapshot of the endpoint is taken using the AutoPack tool; typically, the snapshot includes information about folders and files, registry keys, initialization programs, desktop images, and the like. The process passes to block 334, wherein the package is applied on the endpoint (in order to enforce the desired software features); for this purpose, the external installation program included in the package is launched. As soon as the installation has been completed, a further snapshot of the endpoint is taken at block 336. With reference now to block 338, the AutoPack tool identifies any differences in the configuration of the endpoint resulting from the application of the package; for each difference, an action with a possible installable object (required for reaching the state of the respective resource after the installation from its state before the installation) is generated and added to a new reversed package. At the end of this phase (block 339), the reversed package is complete with all the actions and the installable objects corresponding to the native package that has been just applied. The reversed package is stored into the corresponding repository at block 340. The flow of activity then descends into block 342.

Considering now block 342, the list of the actions executed on the endpoint (either as defined in the bundled package directly or as inferred by the AutoPack tool) is returned to the configuration server, together with information about the result of their execution. In response thereto, the planner at block 344 updates the information relating to the endpoint in the corresponding database. A test is then made at block 346 to determine whether all the activities of the plan have been processed. If not, the method returns to block 310 to repeat the same operations for a next activity. Conversely, the process ends at the concentric black/white stop circles 348.

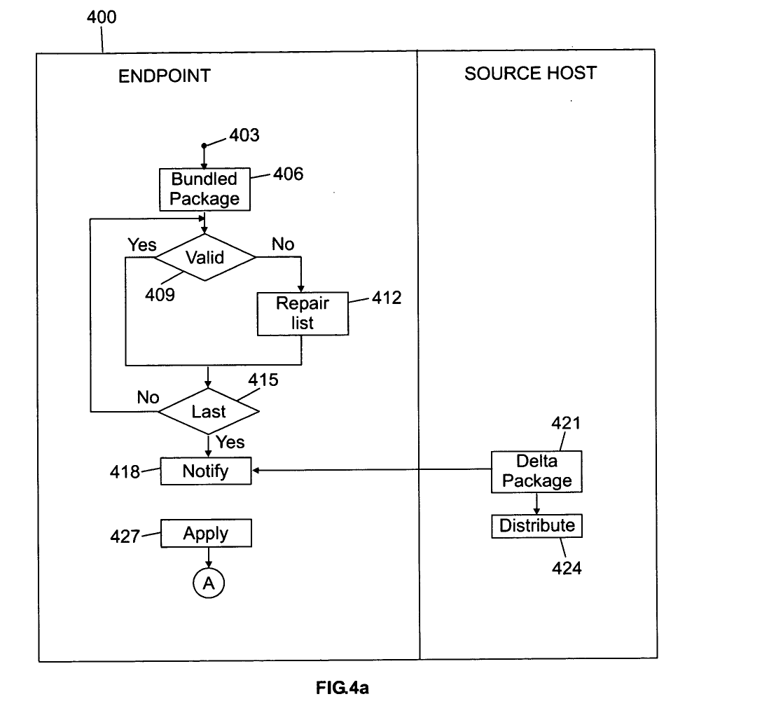

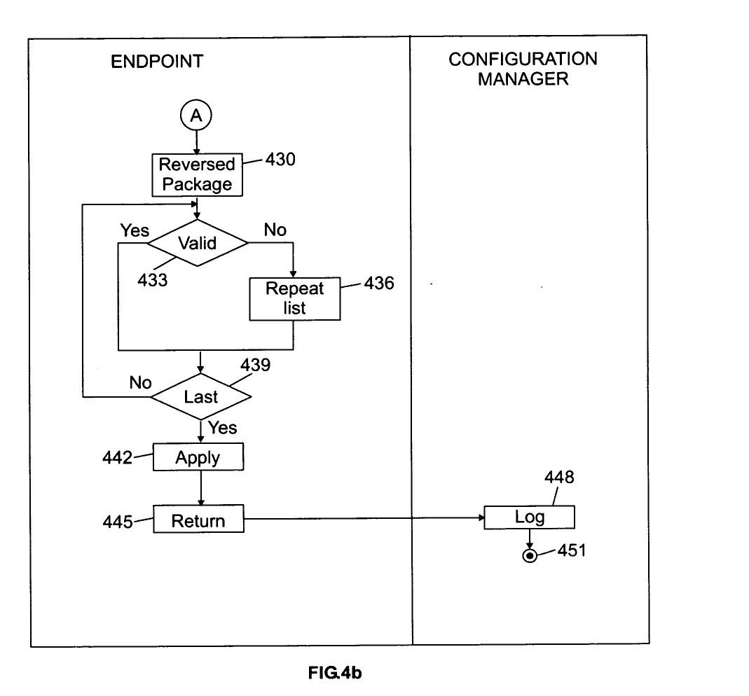

With reference now to FIGS. 4a-4b, the flow of activities relating to a repair process that can be implemented in the above-described scenario is illustrated. The repair process implements a method 400, which begins at the black start circle 403 in the swim-lane of a generic endpoint; for example, the process is executed periodically, following a request received from the configuration server, or upon detection of a change in the (hardware or software) configuration of the endpoint.

In response thereto, the monitor at block 406 retrieves the actions, included in the bundled packages, which have been applied on the endpoint (from the corresponding repository). For each action (starting from the first one), a test is made at block 409 to verify whether the action is still in place. If the corresponding resource is not in the target state specified in the action, the action is inserted into a repair list at block 412; the method then continues to block 415. Conversely, if the endpoint is complaint to the action the flow of activity descends into block 415 directly. Considering now block 415, a test is made to determine whether the last action of the repository has been processed. If not, the method returns to block 409 for verifying a next action.

As soon as all the actions have been processed, the method enters block 418 wherein the repair list is notified to the source host. In response thereto, the source host at block 421 builds a delta package (including the required installable objects) for restoring the target state of the resources specified in the actions of the repair list. Continuing to block 424, the delta package is distributed to the endpoint. Returning to the swim-lane of the endpoint, the delta package is applied at block 427 (repeating the operations described above).

The process then continues to block 430, wherein the monitor retrieves the actions included in the reversed packages that have been stored on the endpoint. For each action (starting from the first one), a test is made at block 433 to verify whether the action is still in place. If the corresponding resource is not in the target state specified in the action, the action is inserted into a repeat list at block 436; the method then continues to block 439. Conversely, if the endpoint is complaint to the action the flow of activity descends into block 439 directly. Considering now block 439, a test is made to determine whether the last action of the reversed packages has been processed. If not, the method returns to block 433 for verifying a next action. As soon as all the actions have been processed, the actions of the repeat list are re-executed on the endpoint directly at block 442 (being the corresponding installable objects already available in the reversed packages).

Continuing to block 445, the result of the application of the actions in the repair list and in the repeat list is returned to the configuration server. In response thereto, the information relating to the endpoint in the corresponding database is updated accordingly at block 448. The method then ends at the concentric black/white stop circles 451.

Similar considerations apply if equivalent methods are performed. In any case, the concepts of the present invention are also applicable when the packages are distributed to the endpoints by the configuration server, when the installable objects of the bundled packages are logged on each endpoint as well, or when the target state of the resources is restored using equivalent correction actions.

More generally, the present invention proposes a software distribution method. The method starts with the step of providing a package (for enforcing desired software features) to a target computer. A starting configuration of the target computer is at first detected. The method continues applying the package on the target computer. An ending configuration of the target computer (resulting from the application of the package) is then detected. The method further includes the step of determining one or more actions, which have been executed on the target computer for reaching the ending configuration from the starting configuration; the actions are determined according to a comparison between the starting configuration and the ending configuration. The method ends with the step of verifying the compliance of the target computer to the actions.

The solution of the invention makes it possible to verify the compliance of the endpoints to the software configurations enforced by the external installation programs.

In this way, it is possible to detect any inconsistencies of the endpoints with respect to the desired software configurations.

As a consequence, the method of the invention provides a complete data integrity solution, which supports the monitoring of any kind of products.

These results are achieved using the original external installation programs; therefore, the enforcing of incorrect software configurations is prevented.

Particularly, the devised solution avoids forcing incompatible hardware settings on the endpoints.

In addition, the method of the invention does not affect any warranty provided for the external installation programs.

The preferred embodiment of the invention described above offers further advantages.

Particularly, any action to which the endpoint is not complaint is re-executed.

In this way, the desired state for the resources that are not complaint to the corresponding actions is automatically restored.

As a further enhancement, the reversed packages (with the actions and the corresponding installable objects) are stored locally.

Therefore, any entity that has been corrupted or deleted can be repaired directly on the endpoint (without requiring a new distribution process). It should be noted that this feature does not involve an excessive duplication of information, since each reversed package is specific for the corresponding endpoint (contrary to the bundled packages).

Preferably, information about the reversed packages is returned to the configuration server.

This additional feature makes it possible to trace all the operations that have been executed on the endpoints from a central site.

However, the solution according to the present invention leads itself to be implemented using the result of the verification carried out on the endpoints for different purposes; for example, the detection of any inconsistency causes a new application of the complete native package or the information is used for reporting only. Alternatively, the installable objects for the reversed packages can be stored on the source host (for example, when the endpoints consist of devices with a low memory capacity), or no information about the reversed packages is returned to the configuration server.

A suggested choice for controlling the distribution process is to add an introspection attribute to the packages.

The proposed feature is very simple but at the same time ensures a high degree of flexibility. In this way, for example, it is possible to enable the generation of the reversed packages only for some critical products.

The devised solution has been specifically designed for the verification of external installation programs.

Alternatively, the generation of the reversed packages is always enabled for all the native packages or it can be selectively disabled on each endpoint. Moreover, the proposed technique can be used in different situations (for example, when the package includes a call to a generic executable program).

Advantageously, the solution according to the present invention is implemented with a computer program, which is provided as a corresponding product stored on a suitable medium.

Alternatively, the program is pre-loaded onto the hard-disks, is sent to the computers through a network (typically the INTERNET), is broadcasted, or more generally is provided in any other form directly loadable into the working memories of the computers. However, the method according to the present invention leads itself to be carried out even with a hardware structure (such as integrated in a chip of semiconductor material), or with a combination of software and hardware.

The method of the invention is specifically designed for application in a data processing system with a distributed architecture, wherein the packages are deployed to the endpoints under the control of a configuration server. However, the use of the proposed solution in a different scenario (for example, when the packages are distributed on CD-ROMs) is not excluded.

Naturally, in order to satisfy local and specific requirements, a person skilled in the art may apply to the solution described above many modifications and alterations all of which, however, are included within the scope of protection of the invention as defined by the following claims.

1. A software distribution method including the steps of:
providing a package for enforcing desired software features to a target computer,
detecting a starting configuration of the target computer,
applying the package on the target computer,
detecting an ending configuration of the target computer resulting from the application of the package,
determining at least one action executed on the target computer for reaching the ending configuration from the starting configuration according to a comparison between the starting configuration and the ending configuration, and
verifying the compliance of the target computer to the at least one action.

2. The method according to claim 1, wherein each action enforces a target state for a resource of the target computer, the method further including the step of:
re-executing each action to which the target computer is not compliant for restoring the target state of the corresponding resource.

3. The method according to claim 2, further including the steps of:
identifying an entity required for enforcing the target state for the resource of each action, and
storing the at least one action with the corresponding entity on the target computer.

4. The method according to claim 1, further including the steps of:
transmitting the package to the target computer under the control of a configuration server, and
returning an indication of the at least one action to the configuration server from the target computer.

5. The method according to claim 1, wherein an introspection attribute is associated with the package, the steps of detecting the starting configuration, detecting the ending configuration and determining the at least one action being enabled according to the introspection attribute.

6. The method according to claim 1, wherein the package includes a command for launching an external installation program.

7. A computer program product in a computer readable memory comprising the steps of:
providing a package for enforcing desired software features to a target computer,
detecting a starting configuration of the target computer,
applying the package on the target computer,
detecting an ending configuration of the target computer resulting from the application of the package,
determining at least one action executed on the target computer for reaching the ending configuration from the starting configuration according to a comparison between the starting configuration and the ending configuration, and
verifying the compliance of the target computer to the at least one action, for performing the method.

8. The product accord to claim 7 further comprising the step of:
re-executing each action to which the target computer is not compliant for restoring the target state of the corresponding resource.

9. A software distribution system including means for providing a package for enforcing desired software features to a target computer, means for detecting a starting configuration of the target computer, means for applying the package on the target computer, means for detecting an ending configuration of the target computer resulting from the application of the package, means for determining at least one action executed on the target computer for reaching the ending configuration from the starting configuration according to a comparison between the starting configuration and the ending configuration, and means for verifying the compliance of the target computer to the at least one action.

10. A data processing system with a distributed architecture including a configuration server and a plurality of target computers, the configuration server having means for controlling the transmission of a package for enforcing desired software features to selected target computers, and each target computer having means for detecting a starting configuration of the target computer, means for applying the package on the target computer, means for detecting an ending configuration of the target computer resulting from the application of the package, means for determining at least one action executed on the target computer for reaching the ending configuration from the starting configuration according to a comparison between the starting configuration and the ending configuration, and means for verifying the compliance of the target computer to the at least one action.
